(19) United States
(12) Patent Application Publication
(10) Pub. No.: US 2015/0291840 A1
(43) Pub. Date: Oct. 15, 2015

(54) COATING AGENT FOR MATTABLE COATINGS

(71) Applicant: BAYER MATERIALSCIENCE AG, Monheim Am Rhein (DE)

(72) Inventors: Marc Claudius Schrinner, Caojing (CN); Heinz-Dietmar Gewiss, Meerbusch (DE); Uwe Klippert, Burscheid (DE); Martin Melchiors, Leichlingen (DE)

(73) Assignee: BAYER MATERIALSCIENCE AG, Leverkusen (DE)

(21) Appl. No.: 14/438,954

(22) PCT Filed: Oct. 25, 2013
(86) PCT No.: PCT/EP2013/072400

§ 371 Date: Apr. 28, 2015

(30) Foreign Application Priority Data
Oct. 29, 2012 (EP) 12190315.7

(51) Int. Cl. C09D 175/06; C08K 3/36

(52) U.S. Cl. CPC C09D 175/06; C08K 3/36

(57) ABSTRACT

The present invention relates to a coating composition that is suitable in particular for the production of coatings that can be matted. The coating composition comprises a) an aqueous dispersion of a hydroxy-functional prepolymer, obtainable by reaction of at least the following components: i) a component comprising hydroxy groups, ii) a polyester polyol comprising hydroxy groups, iii) a polyisocyanate comprising isocyanate groups, iv) a compound which comprises at least two groups reactive towards isocyanate groups and at least one group capable of anion formation, v) water, wherein components i)-iii) and the ratio of components i)-iii) are so chosen that an excess of hydroxy groups is present relative to the isocyanate groups, b) nanoparticles having a number-average particle size of from 1 to 1000 nm, and c) a crosslinker comprising at least two groups reactive towards hydroxy groups. The invention further provides a process for the preparation of the coating composition, the use of the coating composition for producing a coating on a substrate, and a coating obtainable by applying the coating composition to a substrate.

The present invention relates to a coating composition that is suitable in particular for the production of matt, resilient coatings. The invention further provides a process for the preparation of the coating composition, the use of the coating composition for producing a coating on a substrate, and a coating obtainable by applying the coating composition to a substrate.

In the prior art, polymer systems are described which can be used to produce on substrates coatings that have high mechanical and chemical stability. Such systems are described, for example, in EP 1 418 192 A1. The coating compositions of this prior art are based on aqueous polyurethane resins, which are obtainable by reaction of polycarbonate polyols, polyisocyanates, and compounds capable of anion formation with at least two groups reactive towards isocyanate groups.

The provision of matt, and in particular deep-matt, coatings with high flexibility or formability presents a particular problem, because the production of very low gloss values requires the use of correspondingly large amounts of matting agents. However, high concentrations of matting agents in the cured coatings influence their properties, for example their flexibility and formability, in a negative manner (for example, crack formation occurs). For many applications, therefore, coatings are desirable that can readily be matted, that is to say that lose as few of their mechanical properties as possible on matting to very low gloss values.

Coatings produced with the aid of the coating compositions known from EP 1 418 192 A1 do not have sufficient resilience in deep-matt formulations; in addition, their ability to be matted is too low.

The object of the present invention was, therefore, to provide a coating composition with which matt and at the same time highly resilient coatings can be produced. The underlying binders must have a very good ability to be matted.

The object is achieved by a coating composition comprising
a) an aqueous dispersion of a hydroxy-functional prepolymer, obtainable by reaction of at least the following components:
   i) a component comprising hydroxy groups,
   ii) a polyester polyol comprising hydroxy groups,
   iii) a polyisocyanate comprising isocyanate groups,
   iv) a compound which comprises at least two groups reactive towards isocyanate groups and at least one group capable of anion formation,
   v) water,
   wherein components i)-iii) and the ratio of components i)-iii) are so chosen that an excess of hydroxy groups is present relative to the isocyanate groups,
b) nanoparticles having a number-average particle size of from 1 to 1000 nm, and
c) a crosslinker comprising at least two groups reactive towards hydroxy groups.

It has been found, surprisingly, that coatings applied to substrates with the aid of the coating compositions according to the invention exhibit high resilience while having a very low gloss level. Therefore, these coatings withstand mechanical forming, even with large expansions, without being damaged.

In the present case, a group reactive towards isocyanate groups is understood as being a group that is able to react with an isocyanate group with the formation of a covalent bond. Examples of groups reactive towards isocyanate groups are hydroxyl groups and amine groups.

A group capable of anion formation is in the present case understood as being a group that can change from the molecular state into the anionic state. Suitable for this purpose are, for example, dicarboxylic acids, hydroxymonocarboxylic acid or dihydroxymonocarboxylic acid.

Examples of suitable dicarboxylic acids are phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, 2,2-dimethylsuccinic acid. The corresponding anhydrides of these acids can likewise be suitable.

It is also possible to use monocarboxylic acids, such as, for example, benzoic acid and hexanecarboxylic acid. Provided that the functionality of the polyol is greater than 2. Saturated aliphatic or aromatic acids are preferred. These are, for example, adipic acid or isophthalic acid. If desired, it is likewise possible to use small amounts of polycarboxylic acid, such as, for example, trimellitic acid.

Hydroxycarboxylic acids that serve as reactants in the preparation of the polyester polyols carry terminal hydroxyl groups. These are, for example, hydroxycaproic acid, hydroxybutyric acid, hydroxydecanoic acid, hydroxystearic acid and other corresponding acids. Suitable lactones are, for example, caprolactone or butyrolactone.

According to a first preferred embodiment of the invention, the nanoparticles can have a number-average particle size of from 1 to 1000 nm, preferably from 2 to 500 nm and particularly preferably from 5 to 100 nm.

The number-average particle size of the nanoparticles can be determined by transmission electron microscopy, light scattering, analytical ultracentrifugation or photon correlation spectroscopy.

It is likewise preferred for the nanoparticles to have a specific surface area of from 100 m²/g to 1000 m²/g, preferably from 200 to 500 m²/g and particularly preferably from 250 to 400 m²/g.

The specific surface area of the nanoparticles can be determined according to the BET method (DIN ISO 9277:2003-05).

It is further preferred, that the nanoparticles are selected from the group of inorganic nanoparticles.

The nanoparticles can in particular comprise or consist of silicon dioxide, titanium dioxide, aluminium oxide, aluminium dioxide, manganese dioxide, manganese oxide, zinc oxide, zinc dioxide, cerium oxide, cerium dioxide, iron oxide, iron dioxide and/or calcium carbonate. It is also further preferred, that the nanoparticles can comprise or consist of silicon dioxide, titanium dioxide, aluminium oxide, aluminium dioxide, manganese dioxide, manganese oxide, zinc oxide, zinc dioxide, cerium oxide, cerium dioxide and/or calcium carbonate. Particularly preferably, they can consist of silicon dioxide.

In a further development of the invention it is provided that the coating composition additionally comprises at least one matting agent d).

Examples of suitable matting agents are Acematt 3300, 3200 from Evonik, as well as TS 100 and OK 412 from Evonik.

The component i) comprising hydroxy groups can be, for example, ethylene glycol, 1,2- and 1,3-propylene glycol, 1,3-, 1,4- and 2,3-butanediol, 1,6-hexanediol, 2,5-hexanediol, trimethylhexanediol, diethylene glycol, triethylene glycol, hydrogenated bisphenol, 1,4-cyclohexanediol, 1,4-cyclohexanedimethanol, neopentyl glycol and/or trimethylpentanediol, trimethylolpropane and/or glycerol.

It is further preferred, that the component i) comprising hydroxyl groups is different from component ii). In the present case, “different from” preferably means that the components i) and ii) have different chemical structures.

According to a further preferred embodiment, the component i) comprising hydroxy groups can comprise or consist of a polycarbonate polyol.

Suitable polycarbonates are obtainable, for example, by reaction of diphenyl carbonate, dimethyl carbonate or phosgene with polyols, preferably diols. There can be used as diols, for example, ethylene glycol, 1,2- and 1,3-propanediol, 1,3- and 1,4-butanediol, 1,6-hexanediol, 1,8-octanediol, neopentyl glycol, 1,4-bishydroxymethyl-cyclohexane, 2-methyl-1,3-propanediol, 2,2,4-trimethyl-1,3-pentanediol, dipropylene glycol, polypropylene glycols, dibutylene glycol, polybutylene glycols, bisphenol A, tetrabromobisphenol A, but also lactone-modified diols. It is preferred for the diol to comprise from 40 to 100 wt. % hexanediol, preferably 1,6-hexanediol, and/or hexanediol derivatives, particularly preferably those which, as well as comprising terminal OH groups, comprise ether groups or ester groups, for example products obtained by reaction of 1 mol of hexanediol with at least 1 mol, preferably from 1 to 2 mol, of caprolactone or by etherification of hexanediol with itself to form di- or tri-hexylene glycol.

The polyether polycarbonate diols described in DE-A 37 17 060 can also be used.

The polycarbonate polyols are preferably linear in structure. However, they can optionally be branched slightly by the incorporation of polyfunctional components, in particular low molecular weight polyols. There are suitable for that purpose, for example, glycerol, trimethylolpropane, 1,2,6-hexanetriol, 1,2,4-butanetriol, trimethylolethane, pentaerythritol, quinitol, mannitol, and sorbitol, methyl glycoside or 1,3:4,6-dianhydrohexite.

It is also preferred for the polycarbonate polyol to have a weight-average molecular weight of from 500 to 3000 g/mol, preferably from 650 to 2500 g/mol and particularly preferably from 1000 to 2200 g/mol.

The weight-average molecular weight of the polycarbonate polyol can be determined by means of GPC (gel permeation chromatography).

The polyester polyol ii) comprising hydroxy groups can in particular be compounds that have a number-average molecular weight Mₙ of from 400 to 6000 Da and preferably from 600 to 3000 Da. Their hydroxyl number can be from 22 to 400, preferably from 50 to 300 and particularly preferably from 80 to 200 mg KOH/g. The OH functionality can be in the range of from 1.5 to 6, preferably from 1.8 to 3 and particularly preferably from 1.9 to 2.5.

Very suitable polyester polyols ii) comprising hydroxy groups are the polycondensation products, known per se, of di- and optionally poly-(tri-, tetra-)ols and di- and optionally poly-(tri-, tetra-)carboxylic acids or hydroxycarboxylic acids or lactones. Instead of the free polycarboxylic acids, the corresponding polycarboxylic acid anhydrides or corresponding polycarboxylic acid esters of lower alcohols can also be used for the preparation of the polyesters. Examples of suitable diols are ethylene glycol, butylene glycol, diethylene glycol, triethylene glycol, polyalkylene glycols such as polyethylene glycol, also propanediol or (1,4)butanediol, with (1,6)hexanediol, neopentyl glycol or hydroxypivalic acid neopentyl glycol ester being preferred. Polyols such as, for example, trimethylolpropane, glycerol, erythritol, pentaerythritol, trimethylolbenzene or trishydroxyethyl isocyanurate can optionally also be used concomitantly.

Suitable dicarboxylic acids are, for example, phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, 2,2-dimethylsuccinic acid. The possible anhydrides of these acids are likewise suitable. Within the scope of the present invention, the anhydrides are always included in the term “acid”.

Monocarboxylic acids, such as benzoic acid and hexanecarboxylic acid, can also be used, provided that the mean functionality of the polyol is higher than 2. Saturated aliphatic or aromatic acids such as adipic acid or isophthalic acid are preferred. Smaller amounts of polycarboxylic acid, such as trimellitic acid, can also optionally be used concomitantly.

Hydroxycarboxylic acids that can be used as reactants in the preparation of a polyester polyol having terminal hydroxyl groups are, for example, hydroxycaproic acid, hydroxybutyric acid, hydroxydecanoic acid, hydroxystearic acid and the like. Suitable lactones are, for example, caprolactone or butyrolactone.

Suitable polyisocyanates iii) are, for example, diisocyanates of the molecular weight range from 140 to 400 having aliphatically, cycloaliphatically, araliphatically and/or aromatically bonded isocyanate groups, such as, for example, 1,4-diisocyanatobutane, 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis-(isocyanatomethyl)-cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-1-methyl-4(3)isocyanatomethylcyclohexane, bis-(isocyanatomethyl)-norbornane, 1,3- and 1,4-bis-(2-isocyanato-prop-2-yl)-benzene (TMXDI), 2,4- and 2,6-diisocyanatotoluene (TDI), 2,4′- and 4,4′-diisocyanatodiphenylmethane, 1,5-diisocyanatonaphthalene or arbitrary mixtures of such diisocyanates. Preference is given to polyisocyanates or polyisocyanate mixtures of the mentioned type having solely aliphatically and/or cycloaliphatically bonded isocyanate groups. Particular preference is given to polyisocyanates or polyisocyanate mixtures based on HDI, IPDI and/or 4,4′-diisocyanatodicyclohexylmethane.

In addition to these simple diisocyanates, polyisocyanates that contain heteroatoms in the radical linking the isocyanate groups and/or that have a functionality of more than 2 isocyanate groups per molecule are also suitable. The first-mentioned are, for example, polyisocyanates having a uretdione, isocyanurate, urethane, allophanate, biuret, carbodiimide, iminooxadiazinedione and/or oxadiazinetrione structure, composed of at least two diisocyanates and prepared by modification of simple aliphatic, cycloaliphatic, araliphatic and/or aromatic diisocyanates; as an example of an unmodified polyisocyanate having more than 2 isocyanate groups per molecule there may be mentioned, for example, 4-isocyanatomethyl-1,8-octane diisocyanate (nonane triisocyanate).

The polyisocyanate iii) can in particular comprise an aliphatic isocyanate, preferably an aliphatic diisocyanate and particularly preferably at least one compound selected from the group of hexamethylene diisocyanate, isophorone diisocyanate, 1-isocyanato-4-[(4-isocyanatocyclohexyl)methyl]cyclohexane.

The compound iv) can be ionic or potentially ionic compounds. Examples are mono- and dihydroxycarboxylic acids, mono- and di-aminocarboxylic acids, mono- and di-hydroxysulfonic acids, mono- and di-aminosulfonic acids and their salts, such as dihydroxycarboxylic acids, hydroxypivalic acid, N-(2-aminoethyl)-3,3-alanine, 2-(2-amino-ethylamino)-ethanesulfonic acid, ethylenediamine-propyl- or -butyl-sulfonic acid, 1,2- or 1,3-propylenediamine-3-ethylsulfonic acid, lysine, 3,5-diaminobenzoic acid, the hydrophilising agent according to Example 1 of EP-A 0 916 647 and alkali and/or ammonium salts thereof; the adduct of sodium bisulfite with 2-butene-1,4-diol polyether sulfonate, or the propoxylated adduct of 2-butenediol and NaHSO₃) (e.g. in DE-A 2 446 440, pages 5-9, formulae I-III). Preferred ionic or potentially ionic compounds are those which have carboxy and/or carboxylate groups. Particularly preferred ionic compounds are dihydroxycarboxylic acids, in particular α,α-dimethylolalkanoic acids, such as 2,2-dimethylolacetic acid, 2,2-dimethylolpropionic acid, 2,2-dimethylolbutyric acid, 2,2-dimethylolpentanoic acid or dihydroxysuccinic acid.

In the preparation of the hydroxy-functional prepolymer a) there can additionally also be reacted concomitantly low molecular weight chain extenders having a molecular weight in the range of from 60 to 400 Da and preferably from 62 to 200 Da and at least two isocyanate-reactive groups. The chain extenders can be, for example, polyols or polyamines.

Polyols suitable as chain extenders can be compounds having up to 20 carbon atoms per molecule, such as, for example, ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, hydroquinone dihydroxyethyl ether, bisphenol A [2,2-bis(4-hydroxyphenyl)propane], hydrogenated bisphenol A (2,2-bis(4-hydroxycyclohexyl)propane) and mixtures thereof, as well as trimethylolpropane, glycerol or pentaerythritol. Ester diols such as, for example, δ-hydroxybutyl-ε-hydroxycaproic acid ester, ω-hydroxy-hexyl-γ-hydroxybutyric acid ester, adipic acid (β-hydroxyethyl) ester or terephthalic acid bis(β-hydroxyethyl) ester can also be used.

Suitable polyamines for the chain extension are, for example, ethylenediamine, 1,2- and 1,3-diaminopropane, 1,4-diaminobutane, 1,6-diaminohexane, isophoronediamine, the isomer mixture of 2,2,4- and 2,4,4-trimethylhexamethylenediamine, 2-methylpentamethylenediamine, diethylenetriamine, 1,3- and 1,4-xylylenediamine, α,α,α′,α′-tetramethyl-1,3- and -1,4-xylylenediamine and 4,4-diaminodicyclohexylmethane, dimethylethylenediamine, hydrazine or adipic acid dihydrazide.

In the preparation of the hydroxy-functional prepolymer a), a chain terminator can also be reacted concomitantly. These structural units are derived, for example, from monofunctional compounds that are reactive with isocyanate groups, such as monoamines, in particular mono-secondary amines, or monoalcohols. Particular mention may be made here of methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine or substituted derivatives thereof, amidoamines of diprimary amines and monocarboxylic acids, monoketimines of diprimary amines, primary/tertiary amines, such as, for example, N,N-dimethylaminopropylamine.

There can also be used for the polyurethane resin units that are localised at the chain ends and cover it. These units originate on the one hand from monofunctional, isocyanate-reactive components, in particular mono-secondary amines or monoalcohols. Some of these substances are mentioned by way of example hereinbelow: methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, or substituted derivatives of the mentioned compounds. Amidoamines of diprimary amines and mono, monocarboxylic acids, monoketimines of the diprimary amines, primary/secondary/tertiary amines, such as, for example, N,N-dimethylaminopropylamine, methyldimethylamine.

Compounds that are likewise suitable are substances that comprise active hydrogen atoms, which can differ in terms of reactivity between the isocyanate groups. These are, for example, molecules that, as well as comprising a primary amino group, also comprise a secondary amino group or, as well as comprising an OH group, also comprise a COOH group or, as well as comprising an amino group (primary or secondary), also comprise OH groups. Preference is given to components that, as well as comprising an amino group (primary or secondary), also comprise OH groups. Examples of such primary/secondary amines are: 3-amino-1-methylaminopropane, 3-amino-1-ethylaminopropane, 3-amino-1-cyclohexylaminopropane, 3-amino-1-methylaminobutane; mono-hydroxy-carboxylic acids, such as, for example, hydroxyacetic acid, lactic acid or maleic acid, and also alkanolamines such as, for example, N-aminoethylethanolamine, ethanolamine, 3-aminopropanol, neopentanolamine, and, with corresponding preference, diethanolamine, methyldiethanolamine. In this manner it is possible to introduce additional functional groups into the polymer.

Also suitable as chain terminators are compounds that comprise active hydrogen atoms of differing reactivity towards isocyanate groups. These are, for example, compounds that, as well as comprising a primary amino group, also comprise secondary amino groups or, as well as comprising an OH group, also comprise COOH groups or, as well as comprising an amino group (primary or secondary), also comprise OH groups. Preference is given to compounds that, as well as comprising an amino group (primary or secondary), also comprise OH groups. Examples thereof are primary/secondary amines, such as 3-amino-1-methylaminopropane, 3-amino-1-ethylaminopropane, 3-amino-1-cyclohexylaminopropane, 3-amino-1-methylaminobutane; mono-hydroxycarboxylic acids, such as hydroxyacetic acid, lactic acid or malic acid, and also alkanolamines such as N-aminoethylethanolamine, ethanolamine, 3-aminopropanol, neopentanolamine and, particularly preferably, diethanolamine. In this manner it is additionally possible to introduce functional groups into the polymeric end product.

It is likewise possible for compounds having a non-ionically hydrophilising action, for example polyoxyalkylene ethers having at least one hydroxy group or amino group, also to be reacted concomitantly in the preparation of the hydroxy-functional prepolymer a). These polyethers comprise an amount of from 30 wt. % to 100 wt. % of structural units derived from ethylene oxide. There are suitable polyethers with a linear structure having a functionality of from 1 to 3, but also compounds of the general formula (I)

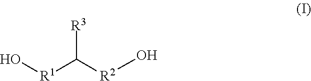

in which
R₁ and R each independently of the other represents a divalent aliphatic, cycloaliphatic or aromatic radical having from 1 to 18 carbon atoms, which may be interrupted by oxygen and/or nitrogen atoms, and
R₃ represents a non-hydroxy-terminated polyester or, preferably, polyether, in particular an alkoxy-terminated polyethylene oxide radical.

The urethanisation reaction in the prepolymer preparation can be carried out at temperatures of from 0° to 140° C., depending on the reactivity of the polyisocyanate used. In order to accelerate the urethanisation reaction, suitable catalysts as are known to the person skilled in the art for accelerating the NCO—OH reaction can be used. Examples are tertiary amines such as, for example, triethylamine, organotin compounds such as, for example, dibutyltin oxide, dibutyltin dilaurate or tin bis(2-ethylhexanoate) or other organometallic compounds.

Compounds suitable as crosslinkers are melamine-formaldehyde or urea-formaldehyde condensation products, as are described, for example, in D. H. Solomon, The Chemistry of Organic Filmformers, pages 235 if, John Wiley & Sons, Inc., New York, 1967. The melamine resins can, however, also be replaced wholly or partially by other amine resins as are described, for example, in Methoden der organischen Chemie (Houben-Weyl), Vol. 14/2, Part 2, 4th Edition, Georg Thieme Verlag, Stuttgart, 1963, pages 319 f.

Other suitable crosslinking resins are blocked polyisocyanates based, for example, on isophorone diisocyanate, hexmethylene diisocyanate, 1,4-diisocyanatocyclohexane, bis-(4-isocyanatocyclohexyl)-methane, 1,3-diisocyanatobenzene, 1,4-diisocyanatobenzene, 2,4-diisocyanato-1-methylbenzene, 1,3-diisocyanato-2-methylbenzene, 1,3-bis-isocyanatomethyl-benzene, 2,4-bis-isocyanatomethyl-1,5-dimethylbenzene, bis-(4-isocyanatophenyl)-propane, tris-(4-isocyanatophenyl)methane and/or trimethyl-1,6-diisocyanatohexane.

There are further suitable also blocked isocyanate adducts such as, for example, biuret polyisocyanates based on 1,6-diisocyanatohexane; isocyanurate polyisocyanates based on 1,6-diisocyanatohexane; or urethane-modified polyisocyanate adducts prepared from 2,4- and/or 2,6-diisocyanatotoluene or isophorone diisocyanate and low molecular weight polyhydroxyl components (such as, for example, trimethylolpropane, the isomeric propanediol or butanediol or mixtures of such polyhydroxyl components), wherein the isocyanate group of the polyisocyanate adduct is blocked.

Suitable blocking agents for these polyisocyanates are monofunctional alcohols, such as methanol, ethanol, butanol, hexanol and benzyl alcohol; oximes such as acetoxime and methyl ethyl ketoxime; lactams such as epsilon-caprolactam; phenol; and CH-acidic components such as, for example, diethyl malonate.

Suitable crosslinkers are also polyisocyanate crosslinkers, amide- and amine-formaldehyde resins, phenolic resins, aldehyde resins and ketone resins, such as, for example, phenol formaldehyde resin, resols, furan resins, urea resins, carbamic ester resins, triazine resins, melamine resins, benzoguanamine resins, cyanamide resins, aniline resins, as described in “Lackharze”, D. Stoye, W. Freitag, Carl Hanser Verlag, Munich, 1996.

In a preferred embodiment, the crosslinker c) can comprise as hydroxy-reactive groups at least two isocyanate groups.

Suitable isocyanate-functionalised crosslinkers are, for example, low viscosity, hydrophobic or hydrophilised polyisocyanates having free isocyanate groups, based on aliphatic, cycloaliphatic, araliphatic and/or aromatic isocyanates, particularly preferably based on aliphatic or cycloaliphatic isocyanates, because it is thus possible to establish a particularly high level of resistance in the coating film. The advantage of the binder dispersion in this invention is obtained in particular in combination with these crosslinkers. If necessary, the polyisocyanates can also be used in the form of a mixture of the polyisocyanate and small amounts of inert solvents or inert solvent mixtures—in order to reduce the viscosity level. Triisocyanatononanes can likewise be used as the crosslinking component, on their own or in admixture with others.

It is also advantageous for the crosslinker c) to have a viscosity at 23° C. of from 10 to 10,000 mPas.

The viscosity of the crosslinker can be determined in accordance with DIN 53019 with a shear gradient of 40 s⁻¹.

In addition to the aforementioned effects, the inventive coating composition has a high storage stability.

The present invention further provides a process for the preparation of the coating composition according to the invention, in which in a first step the aqueous dispersion a) is prepared, in a second step a mixture of the aqueous dispersion a) and the nanoparticles b) is prepared, and in a third step the crosslinker is added to the mixture.

The invention likewise provides the use of the coating composition according to the invention for producing a coating on a substrate, in particular on a plastics substrate.

The invention still further provides a coating obtainable by applying the coating composition according to the invention to a substrate, in particular to a plastics substrate.

The invention will be explained in detail hereinbelow by means of examples.

### Methods

Unless indicated otherwise, all amounts in % are based on weight.

Viscosity measurements were carried out in a cone-plate viscometer in accordance with DIN 53019 with a shear gradient of 40 s⁻¹.

The acid number was determined in accordance with DIN 53402 (mg KOH/g of sample, titration with 0.1 mol/litre of NaOH solution).

The solids content was determined in accordance with DIN EN ISO 3251 (thick-layer method: lid, 1 g sample, 1 h 125° C., convection oven).

The OH number was determined in accordance with DIN 53240 (mg KOH/g of sample, acetylation, hydrolysis, titration with 0.1 mol/litre of NaOH).

The pH value was measured in accordance with International Standard ISO 976.

The molecular weight (Mn, Mw) was determined by means of GPC (gel permeation chromatography). The samples were tested in accordance with DIN 55672-1 with tetrahydrofuran as elution solvent. Mn (UV)=number-average molecular weight (GPC, UV detection), result in g/mol; Mw (UV)=weight-average molecular weight (GPC, UV detection), result in g/mol.

The mean particle size was measured by means of laser correlation spectroscopy.

### Substances

Desmorapid SO: Sn(II) octoate
Desmodur W: Diisocyanatodicyclohexylmethane (H12-MDI)
Desmodur H: Hexamethylene diisocyanate (HDI)
Tanafoam DNE 01: antifoam; mixture of fatty acid esters and higher-valent hydrocarbon carboxylic acid salts, Tanatex, DE
BYK 348: Polyether-modified siloxane surfactant, BYK, DE
Aquacer 110 RC 1174: Wax additive, BYK, DE
Tego Wet KL245: Polyethersiloxane copolymer, Evonik, DE
Sillitin Z 86: Clay filler, Hoffmann Mineral, DE
Acematt 3300: Modified pyrogenic silica, Evonik, DE
Desmodur® N 3600: HDI trimer
Bayhydur® XP 2655: Hydrophilised aliphatic polyisocyanate based on HDI
MPA: Methylpropyl acetate(1-methoxy-2-propanol acetate)
Makrofol: Thermoplastic film of polycarbonate, Bayer MaterialScience, DE

### EXAMPLES

### Coating Compositions

### Binders

### Example 1 (According to the Invention)

1281 g of phthalic anhydride, 5058 g of adipic acid, 6387 g of 1,6-hexanediol and 675 g of neopentyl glycol were weighed into a 15-litre reaction vessel having a stirrer, a heating apparatus and a water separator with a cooler, and the mixture was heated to 140° C. in the course of one hour, under nitrogen. In the course of a further 9 hours, the mixture was heated to 220° C. and condensed at that temperature until an acid number less than 3 was reached. The polyester resin so obtained had a viscosity (determined as the runout time of an 80% solution of the polyester in methoxypropyl acetate in a DIN 4 beaker at 23° C.) of 54 seconds and an OH number of 160 mg KOH/g.

2628 g of the above-described polyester were placed, in a nitrogen atmosphere, in a 6-litre reaction vessel having a cooling, heating and stirring apparatus and, together with 2557 g of a linear polyester carbonate diol having a number-average molecular weight of 2000, 280 g of dimethylolpropionic acid, 415 g of trimethylolpropane and 8.8 g of tin(II) octoate, were heated to 130° C. and homogenised for 30 minutes. The mixture was then cooled to 80° C., 1120 g of hexamethylene diisocyanate were added with vigorous stirring, heating to 140° C. was carried out (using the heat of reaction), and the mixture was maintained at that temperature until no further NCO groups were detected.

The polyurethane so obtained was then cooled to 90° C.-100° C., 102 g of dimethylethanolamine (degree of neutralisation 70%) were added, and the mixture was homogenised. Further processing of the resin to a dispersion was then carried out, with vigorous stirring, at a temperature of 70° C.-80° C. by means of demineralised water.

In the course of 10 minutes, an approximately 30 wt. % silicon dioxide nanoparticle dispersion was added to the dispersion so obtained. Homogenisation was then carried out at 40° C. in the course of one hour.

The dispersion so obtained had a solids content of 48.6 wt. %, an acid number of 15.3, a viscosity of 1040 mPas, a pH value of 7.7 and a mean particle size of 166 nm.

### Example 2 (According to the Invention)

1190 g of phthalic anhydride, 5005 g of adipic acid, 6337 g of 1,6-hexanediol and 635 g of neopentyl glycol were weighed into a 15-litre reaction vessel having a stirrer, a heating apparatus and a water separator with a cooler, and the mixture was heated to 140° C. in the course of one hour, under nitrogen. In the course of a further 9 hours, the mixture was heated to 220° C. and condensed at that temperature until an acid number less than 3 was reached. The polyester resin so obtained had a viscosity (determined as the runout time of an 80% solution of the polyester in methoxypropyl acetate in a DIN 4 beaker at 23° C.) of 54 seconds and an OH number of 157 mg KOH/g.

2565 g of the above-described polyester were placed, in a nitrogen atmosphere, in a 6-litre reaction vessel having a cooling, heating and stirring apparatus and, together with 2493 g of a linear polyester carbonate diol having a number-average molecular weight of 2000, 272 g of dimethylolpropionic acid, 409 g of trimethylolpropane and 8.5 g of tin(II) octoate, were heated to 130° C. and homogenised for 30 minutes. The mixture was then cooled to 80° C., 1050 g of hexamethylene diisocyanate were added with vigorous stirring, heating to 140° C. was carried out (using the heat of reaction), and the mixture was maintained at that temperature until no further NCO groups were detected.

The polyurethane so obtained was then cooled to 90° C.-100° C., 93 g of dimethylethanolamine (degree of neutralisation 70%) were added, and the mixture was homogenised. Further processing of the resin to a dispersion was then carried out, with vigorous stirring, at a temperature of 70° C.-80° C. by means of demineralised water.

In the course of 10 minutes, an approximately 30 wt. % silicon dioxide nanoparticle dispersion was added to the dispersion so obtained. Homogenisation was then carried out at 40° C. in the course of one hour.

The dispersion so obtained had a solids content of 47.1 wt. %, an acid number of 14.9, a viscosity of 1006 mPas, a pH value of 7.6 and a mean particle size of 158 nm.

### Example 3 (According to the Invention)

1346 g of phthalic anhydride, 5107 g of adipic acid, 6439 g of 1,6-hexanediol and 706 g of neopentyl glycol were weighed into a 15-litre reaction vessel having a stirrer, a heating apparatus and a water separator with a cooler, and the mixture was heated to 140° C. in the course of one hour, under nitrogen. In the course of a further 9 hours, the mixture was heated to 220° C. and condensed at that temperature until an acid number less than 3 was reached. The polyester resin so obtained had a viscosity (determined as the runout time of an 80% solution of the polyester in methoxypropyl acetate in a DIN 4 beaker at 23° C.) of 54 seconds and an OH number of 166 mg KOH/g.

2716 g of the above-described polyester were placed, in a nitrogen atmosphere, in a 6-litre reaction vessel having a cooling, heating and stirring apparatus and, together with 2643 g of a linear polyester carbonate diol having a number-average molecular weight of 2000, 294 g of dimethylolpropionic acid, 457 g of trimethylolpropane and 9.1 g of tin(II) octoate, were heated to 130° C. and homogenised for 30 minutes. The mixture was then cooled to 80° C., 1205 g of hexamethylene diisocyanate were added with vigorous stirring, heating to 140° C. was carried out (using the heat of reaction), and the mixture was maintained at that temperature until no further NCO groups were detected.

The polyurethane so obtained was then cooled to 90° C.-100° C., 117 g of dimethylethanolamine (degree of neutralisation 70%) were added, and the mixture was homogenised. Further processing of the resin to a dispersion was then carried out, with vigorous stirring, at a temperature of 70° C.-80° C. by means of demineralised water.

In the course of 10 minutes, an approximately 30 wt. % silicon dioxide nanoparticle dispersion was added to the dispersion so obtained. Homogenisation was then carried out at 40° C. in the course of one hour.

The dispersion so obtained had a solids content of 49.8 wt. %, an acid number of 15.9, a viscosity of 1106 mPas, a pH value of 7.9 and a mean particle size of 173 nm.

### Example 4 (not According to the Invention)

1281 g of phthalic anhydride, 5058 g of adipic acid, 6387 g of 1,6-hexanediol and 675 g of neopentyl glycol were weighed into a 15-litre reaction vessel having a stirrer, a heating apparatus and a water separator with a cooler, and the mixture was heated to 140° C. in the course of one hour, under nitrogen. In the course of a further 9 hours, the mixture was heated to 220° C. and condensed at that temperature until an acid number less than 3 was reached. The polyester resin so obtained had a viscosity (determined as the runout time of an 80% solution of the polyester in methoxypropyl acetate in a DIN 4 beaker at 23° C.) of 54 seconds and an OH number of 160 mg KOH/g.

585 g of the above-described polyester were placed, in a nitrogen atmosphere, in a 3-litre reaction vessel having a cooling, heating and stirring apparatus and, together with 570 g of a linear polyester carbonate diol having a number-average molecular weight of 2000, 60 g of dimethylolpropionic acid, 45 g of trimethylolpropane and 1.9 g of tin(II) octoate, were heated to 130° C. and homogenised for 30 minutes. The mixture was then cooled to 80° C., 240 g of hexamethylene diisocyanate were added with vigorous stirring, heating to 140° C. was carried out (using the heat of reaction), and the mixture was maintained at that temperature until no further NCO groups were detected.

The polyurethane so obtained was then cooled to 90° C.-100° C., 102 g of dimethylethanolamine (degree of neutralisation 70%) were added, and the mixture was homogenised. Further processing of the resin to a dispersion was then carried out, with vigorous stirring, at a temperature of 70° C.-80° C. by means of demineralised water.

The dispersion so obtained had a solids content of 53.6 wt. %, an acid number of 18.3, a viscosity of 2360 mPas, a pH value of 7.5 and a mean particle size of 104 nm.

### Example 5 (not According to the Invention)

1281 g of phthalic anhydride, 5058 g of adipic acid, 6387 g of 1,6-hexanediol and 675 g of neopentyl glycol were weighed into a 15-litre reaction vessel having a stirrer, a heating apparatus and a water separator with a cooler, and the mixture was heated to 140° C. in the course of one hour, under nitrogen. In the course of a further 9 hours, the mixture was heated to 220° C. and condensed at that temperature until an acid number less than 3 was reached. The polyester resin so obtained had a viscosity (determined as the runout time of an 80% solution of the polyester in methoxypropyl acetate in a DIN 4 beaker at 23° C.) of 54 seconds and an OH number of 160 mg KOH/g.

2808 g of the above-described polyester were placed, in a nitrogen atmosphere, in a 6-litre reaction vessel having a cooling, heating and stirring apparatus and, together with 145 g of dimethylolpropionic acid, 86 g of trimethylolpropane and 4.5 g of tin(II) octoate, were heated to 130° C. and homogenised for 30 minutes. The mixture was then cooled to 80° C., 580 g of hexamethylene diisocyanate were added with vigorous stirring, heating to 140° C. was carried out (using the heat of reaction), and the mixture was maintained at that temperature until no further NCO groups were detected.

The polyurethane so obtained was then cooled to 90° C.-100° C., 68 g of dimethylethanolamine (degree of neutralisation 70%) were added, and the mixture was homogenised. Further processing of the resin to a dispersion was then carried out, with vigorous stirring, at a temperature of 70° C.-80° C. by means of demineralised water.

In the course of 10 minutes, an approximately 30 wt. % silicon dioxide nanoparticle dispersion was added to the dispersion so obtained. Homogenisation was then carried out at 40° C. in the course of one hour.

The dispersion so obtained had a solids content of 47.1 wt. %, an acid number of 19.9, a viscosity of 1610 mPas, a pH value of 7.8 and a mean particle size of 115 nm.

It was shown that the resulting dispersion had become solid after one month and accordingly could not be investigated further as regards the matting properties of the coating composition to be prepared therefrom.

Coating Production

| | Amount in | A | B |
|---|---|---|---|
| | % based | Dispersion | Dispersion |
| | on solid | from | from |
| | resin | Example 1 | Example 4 |
| Components Part I | | | |
| Binder | | 45.08 | 51.47 |
| Demineralised water | | 28.57 | 24.12 |
| Tanafoam DNE ® 01, as supplied | 0.6 | 0.18 | 0.17 |
| BYK ® 348, as supplied | 1 | 0.30 | 0.28 |
| Tego-Wet ® KL 245, 50% in H₂O | 1.5 | 0.44 | 0.42 |
| Aquacer ® 513, as supplied | 4.3 | 1.27 | 1.20 |
| Sillitin ® Z 86 | 15 | 4.43 | 4.18 |
| Talkum IT extra | 12 | 3.54 | 3.35 |
| Carbon black paste, 40% in H₂O | 12.6 | 3.72 | 3.52 |
| Matting agent Acematt ® 3300 | 8 | 2.36 | 2.23 |
| | | 89.88 | 90.94 |
| Components Part II | | | |
| Desmodur ® N 3600 | 70 | | |
| Bayhydur ® XP 2655 | 30 | | |
| Ratio of the two curing agents | | 10.12 | 9.06 |
| (75% in 1-methoxy-2-propyl acetate) | | | |
| | | 100.00 | 100.00 |
| Composition in % | | | |
| Binder | | 29.5 | 27.9 |
| Water | | 54.2 | 56.8 |
| Co-solvent | | 2.5 | 2.3 |
| Pigments/Additives | | 11.8 | 11.2 |
| Additives | | 2.0 | 1.9 |
| | | 100.0 | 100.0 |
| NCO/OH ratio | | 1.5 | 1.5 |

### Application Test

In order to study the coating profile, aqueous 2K coatings (Examples A and B) were applied to Makrofol sheets, in each case by spraying. The dried coating film was then studied in respect of the gloss values and haptics/resilience.

| Batch | Gloss* (20°/60°/85°) | Haptics/resilience** |
|---|---|---|
| From Example A | 0/0.3/2.8 | 3 |
| From Example B | 0.2/2.2/3.9 | 4 |

*Gloss/haze measurement: reflectometer (haze/gloss), Byk-Gardner type 2.8
**Scale 1-5 (very good-poor): measure of the soft-feel effect, or resilience, of a surface. The softer a coating, the better the rating.

It is clear from these results that significantly more matt films can be produced in the case of the coatings based on Example A. Furthermore, it is also shown that A also yields significantly more resilient coatings.

1.-15. (canceled)

16. A coating composition comprising
a) an aqueous dispersion of a hydroxy-functional prepolymer, obtained by reaction of at least the following components:
i) a component comprising hydroxy groups,
ii) a polyester polyol comprising hydroxy groups,
iii) a polyisocyanate comprising isocyanate groups,
iv) a compound which comprises at least two groups reactive towards isocyanate groups and at least one group capable of anion formation,
v) water,
wherein components i)-iii) and the ratio of components i)-iii) are so chosen that an excess of hydroxy groups is present relative to the isocyanate groups,
b) nanoparticles having a number-average particle size of from 1 to 1000 nm, and
c) a crosslinker comprising at least two groups reactive towards hydroxy groups.

17. The coating composition according to claim 16, wherein the nanoparticles have a number-average particle size of from 2 to 500 nm.

18. The coating composition according to claim 16, wherein the nanoparticles have a specific surface area of from 100 m²/g to 1000 m²/g.

19. The coating composition according to claim 16, wherein the nanoparticles consist of silicon dioxide, titanium dioxide, aluminium oxide, aluminium dioxide, manganese dioxide, manganese oxide, zinc oxide, zinc dioxide, cerium oxide, cerium dioxide, iron oxide, iron dioxide, or calcium carbonate.

20. The coating composition according to claim 16, wherein the composition additionally comprises at least one matting agent d).

21. The coating composition according to claim 16, wherein component i) comprising hydroxy groups comprises or consists of a polycarbonate polyol.

22. The coating composition according to claim 21, wherein the polycarbonate polyol has a weight-average molecular weight of from 500 to 3000 g/mol.

23. The coating composition according to claim 16, wherein the polyisocyanate iii) comprises an aliphatic isocyanate.

24. The coating composition according to claim 16, wherein the crosslinker c) comprises as hydroxy-reactive groups at least two isocyanate groups.

25. The coating composition according to claim 16, wherein the crosslinker c) has a viscosity at 23° C. of from 10 to 10,000 mPas.

26. A process for the preparation of the coating composition according to claim 16, comprising preparing, in a first step, the aqueous dispersion a), preparing, in a second step, a mixture of the aqueous dispersion a) and the nanoparticles b), and adding, in a third step, the crosslinker to the mixture.

27. A method for producing a coating on a substrate comprising applying the coating composition according to claim 16 to the substrate.

28. The method according to claim 27, wherein the substrate is a plastics substrate.

29. A coating obtained by applying a coating composition according to claim 16 to a substrate.

30. The coating according to claim 29, wherein the substrate is a plastics substrate.
